(19) United States
(12) Patent Application Publication
(10) Pub. No.: US 2010/0027115 A1
(43) Pub. Date: Feb. 4, 2010

(54) LENS STRUCTURE FOR AN AUTOSTEREOSCOPIC DISPLAY DEVICE

(75) Inventors: Dirk Kornelis Gerhardus De Boer, Eindhoven (NL); Oscar Hendrikus Willemsen, Eindhoven (NL); Siebe Tjerk De Zwart, Eindhoven (NL); Age Jochem Van Dalfsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,389

(22) PCT Filed: Dec. 12, 2007
(86) PCT No.: PCT/IB07/55040

§ 371 Date: Jun. 16, 2009

(30) Foreign Application Priority Data
Dec. 19, 2006 (EP) 06126463.6

(51) Int. Cl. G02B 27/22

(52) U.S. Cl. 359/463

(57) ABSTRACT

A lens structure for a display device comprises a lenticular arrangement, the lenticular arrangement comprising an array of parallel lenticular elements and comprising a birefringent layer. The extraordinary axis of the birefringent layer is arranged to be substantially at an angle between 30° and 90° with the elongate axis of the lenticular elements.

### FIELD OF THE INVENTION

This invention relates to a lens structure for a display device, and more particularly to a lens structure for an autostereoscopic display device.

### BACKGROUND OF THE INVENTION

A known autostereoscopic display device is illustrated in FIG. 1. This known device 1 comprises a two dimensional liquid crystal display panel 3 having a row and column array of display pixels 5 acting as a spatial light modulator to produce the display. For the sake of clarity, only a small number of display pixels 5 are shown in FIG. 1. In practice, the display panel 3 might comprise about one thousand rows and several thousand columns of display pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarising layers are also provided on the outer surfaces of the substrates.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9, arranged over the display side of the display panel 3, which performs a view forming function. The lenticular sheet 9 comprises an array of lenticular elements 11 extending parallel to one another, of which only one is shown with exaggerated dimensions for the sake of clarity.

Thus, an array of elongate lenticular elements 11 extending parallel to one another overlies the display pixel array, and the display pixels 5 are observed through these lenticular elements 11.

The lenticular elements 11 act as a light output directing means to provide different images, or views, from the display panel 3 to the eyes of a user positioned in front of the display device 1. The above described device provides an effective three dimensional display device (if the image comprises multiple views).

In an arrangement in which, for example, each lenticular element 11 is associated with two columns of display pixels 5, the display pixels 5 in each column provide a vertical slice of a respective two dimensional sub-image. The lenticular sheet 9 directs these two slices and corresponding slices from the display pixel columns associated with the other lenticular elements 11, to the left and right eyes of a user positioned in front of the sheet, so that the user observes a single stereoscopic image.

However, a problem that is associated with the use of cylindrical lenticulars is that, because of field curvature, the focus size changes with viewing angle. This problem is illustrated in FIGS. 2a and 2b, which show rays originating from a pixel at the pixel plane 15 and contributing to an image at a viewing angle of 00° (FIG. 2a), where the focal point P is just behind the pixel plane 15, and at a viewing angle of 50° (FIG. 2b), where the focal point P is in front of the pixel plane 15.

Also, FIG. 3 is a graph illustrating the relationship between intensity and position at the pixel plane contributing to an image for viewing angles between 0° and 50°, wherein the lenticular elements 11 are isotropic. In other words, it shows the positions on the x-axis (in mm) of pixels which contribute to a particular view. From the graph of FIG. 3, it can be seen that the focus size is very large for viewing angles greater than 30°, where a large physical width of pixels contribute to the view (the dotted lines are the results after being convoluted with a top-hat distribution taking into account the effect of pixel size and slant angle). A large focus size is undesirable since it causes excessive overlap between views and therefore reduces the 3D impression.

Another disadvantage of using cylindrical lenticular elements is that vertical lines (perpendicular to the plane of FIG. 2) may be imaged as curved lines.

Thus, it is desirable to create an autostereoscopic display device in which the focus size is reduced for viewing angles greater than 30°. In other words, it is sought-after to reduce the blurring effect that can occur at large viewing angles.

### SUMMARY OF THE INVENTION

According to the invention, there is provided a lens structure for an autostereoscopic display device comprising a lenticular arrangement, the lenticular arrangement comprising an array of parallel lenticular elements and comprising a birefringent layer, wherein the extraordinary axis of the birefringent layer is arranged to be substantially at an angle between 30° and 90° with the elongate axis of the lenticular elements.

By using a birefringent layer within the lenticular arrangement, blurring of images produced by a 3D display may be significantly reduced. In particular, the refractive index boundaries seen by light passing in different lateral directions (between a normal direction to a middle view and a lateral direction to an outermost sideways view) are different. These different refractive index boundaries give rise to different lens focussing effects of the lenticular elements, and these refractive index boundaries can be selected so that a correct area of a display panel is focussed to each viewing position.

The extraordinary axis at a first interface of the birefringent layer can be twisted with respect to that at a second interface of the birefringent layer. A half-lambda wave plate can be provided for rotating the polarisation direction between the interfaces.

The array of lenticular elements may comprise bi-convex lenses.

Preferably, the lenticular arrangement comprises a lens layer and a replica layer arranged over the lens layer. The refractive index of each layer can be selected, and one or both layers may be anisotropic. For the anisotropic layer or layers, the refractive index difference and the axis of anisotropy can be selected. These parameters can all be selected to provide a lens arrangement with the desired focussing properties.

A polarisation means may be arranged over at least a portion of the lenticular arrangement. This can ensure that the light from a display panel has the correct polarization to ensure the angle-dependent lens function is implemented.

The invention also provides an autostereoscopic display device comprising:

a display panel for producing a display; and

a lens structure of the invention.

The display panel output is preferably polarized in a plane perpendicular to the axis of the lenticular elements of the lens structure. The orientation of the extraordinary axis of the birefringent layer can be switchable by selective application of an electric field so as switch the display between 2D and 3D modes of operation.

The invention also provides a method of displaying an autostereoscopic image, comprising:

generating an image comprising multiple views;

projecting the image through a lens structure comprising an array of parallel lenticular elements and comprising a birefringent layer,

wherein the extraordinary axis of the birefringent layer is arranged to be substantially perpendicular to the elongate axis of the lenticular elements, and wherein the generated image is arranged to be polarized in a plane perpendicular to the axis of the lenticular elements of the lens structure.

### BRIEF DESCRIPTION OF THE DRAWINGS

Embodiments of the invention will now be described, purely by way of example, with reference to the accompanying drawings, in which:

FIG. 1 is a schematic perspective view of a known autostereoscopic display device;

FIGS. 2a and 2b, illustrate rays originating from a pixel of a pixel plane and contributing to an image at a viewing angles of 00° and 50°, respectively;

FIG. 3 is a graph illustrating an exemplary relationship between intensity and position at the pixel plane contributing to an image produced by the device of FIG. 1 for viewing angles between 0° and 50°;

FIG. 4 is a schematic cross-sectional view of an autostereoscopic display device according to an embodiment of the invention;

FIG. 5 is a graph illustrating a relationship between intensity and position at the pixel plane contributing to an image produced by the device of FIG. 4 for viewing angles between 0° and 50°;

FIG. 6 is a schematic cross-sectional view of an autostereoscopic display device according to an alternative embodiment of the invention;

FIG. 7 is a graph illustrating a relationship between intensity and position at the pixel plane contributing to an image produced by the device of FIG. 5 for viewing angles between 0° and 50°;

FIG. 8 is a schematic cross-sectional view of an autostereoscopic display device according to yet another alternative embodiment of the invention;

FIG. 9 is a graph illustrating a relationship between intensity and position at the pixel plane contributing to an image produced by the device of FIG. 8 for viewing angles between 0° and 50°;

FIG. 10 is a schematic cross-sectional view of an autostereoscopic display device according to yet another alternative embodiment of the invention;

FIG. 11 is a graph illustrating a relationship between intensity and position at the pixel plane contributing to an image produced by the device of FIG. 10 for viewing angles between 0° and 50°;

FIG. 12 is a schematic cross-sectional view of an autostereoscopic display device according to yet another alternative embodiment of the invention; and

FIG. 13 is a graph illustrating a relationship between intensity and position at the pixel plane contributing to an image produced by the device of FIG. 12 for viewing angles between 0° and 50°.

The dimensions of the diagrams are not to scale and like reference numerals refer to like elements throughout.

### DETAILED DESCRIPTION OF EMBODIMENTS

The invention provides a lens structure for a display device comprising a lenticular arrangement having an array of parallel lenticular elements. The lenticular arrangement includes a birefringent layer having its extraordinary axis not substantially parallel to the elongate axis of the lenticular elements, but preferably at an angle between 30° and 90°. This makes the focussing function dependent on the angle of incidence of the light, and this can be used to reduce significantly a blurring effect present at large viewing angles.

FIG. 4 is a schematic cross-sectional view of an autostereoscopic display device 40 according to an embodiment of the invention. The autostereoscopic display device 40 comprises a two dimensional liquid crystal display panel 42 for producing a display. The structure of the liquid crystal display panel 42 is entirely conventional.

In a similar fashion to a known autostereoscopic display device (as described in the background section of this application), the display panel 42 is illuminated by a light source (not shown). Light from the light source (indicated generally by the arrow labelled “L”) is directed through the display panel 42, with individual display pixels of the display 42 being driven to modulate the light and produce an image.

The autostereoscopic display device 40 also comprises a birefringent lenticular sheet 44 arranged over the display panel 42, wherein the birefringent sheet is optionally separated from the display panel by a glass sheet 43. The birefringent lenticular sheet 44 comprises an array of semi-cylindrical (or planar convex) lenticular elements 46 extending parallel to one another (of which five are shown with exaggerated dimensions for the sake of clarity). The cylindrical axes of the semi-cylindrical lenticular elements 46 are arranged such that they are substantially parallel to each other and the display panel 42 (i.e. into the page).

Thus, an array of elongate lenticular elements 46 extending parallel to one another overlies the display panel 42, and the pixels of the display panels 42 are observed through the lenticular elements 46.

As is known in the field of autostereoscopic display devices, the lenticular elements 42 act as a light output directing means to provide different images, or views, from the display panel 42 to the eyes of a user positioned in front of the display device 40.

In the display device 40 of FIG. 4, however, the lenticular sheet 44 is birefringent and has an ordinary refractive index denoted nₒ and an extraordinary refractive index denoted nₑ.

For uniaxial anisotropy, the ordinary refractive index n₀ is defined as the refractive index for polarizations perpendicular to the axis of anisotropy, and the extraordinary refractive index is defined as the refractive index for polarizations parallel to the axis of anisotropy. The term “extraordinary axis” in the following description is thus used as an equivalent to the “axis of anisotropy”.

The invention is based on arranging the birefringent lenticular means such that the extraordinary axis (as indicated generally by the arrow labelled “A”) is substantially perpendicular to the parallel axis of the lenticular elements 46. The direction of light travelling through the lenticular elements (within a horizontal plane) will alter the relative angles between the polarization of the light and the extraordinary axis, so that the a different refractive index is seen for light at different angles, for example as shown in FIG. 2. This enables the undesirable blurring effect to be significantly reduced.

Taking an extraordinary axis parallel to the plane of the display as an example, such a reduction in the blurring effect can be explained by the fact that light rays at angles encounter an effective refractive index n which is defined the following equation (equation 1):

$$n = \frac{{n}_{o} {n}_{e}}{\sqrt{{n}_{o}^{2} {cos}^{2} θ + {n}_{e }^{2} {sin}^{2} θ}} , \qquad ( 1 )$$

where nₒ and nₑ are the refractive indices for polarizations perpendicular (ordinary) and parallel (extraordinary) to the axis of anisotropy respectively and θ is the angle between the extraordinary axis and the wavevector of the light.

From equation 1, it will be appreciated that the effective index n will be of a value in between that of the ordinary refractive index nₒ and the extraordinary refractive index nₑ. This results in a weaker lensing action, and hence less resultant blurring.

Also, Delta-n (Δn) refers to the birefringence magnitude and is defined by the following equation (equation 2):

Δn=nₑ−nₒ (2).

Thus, when nₑ>nₒ, Δn is positive, and when nₑ<nₒ, Δn is negative.

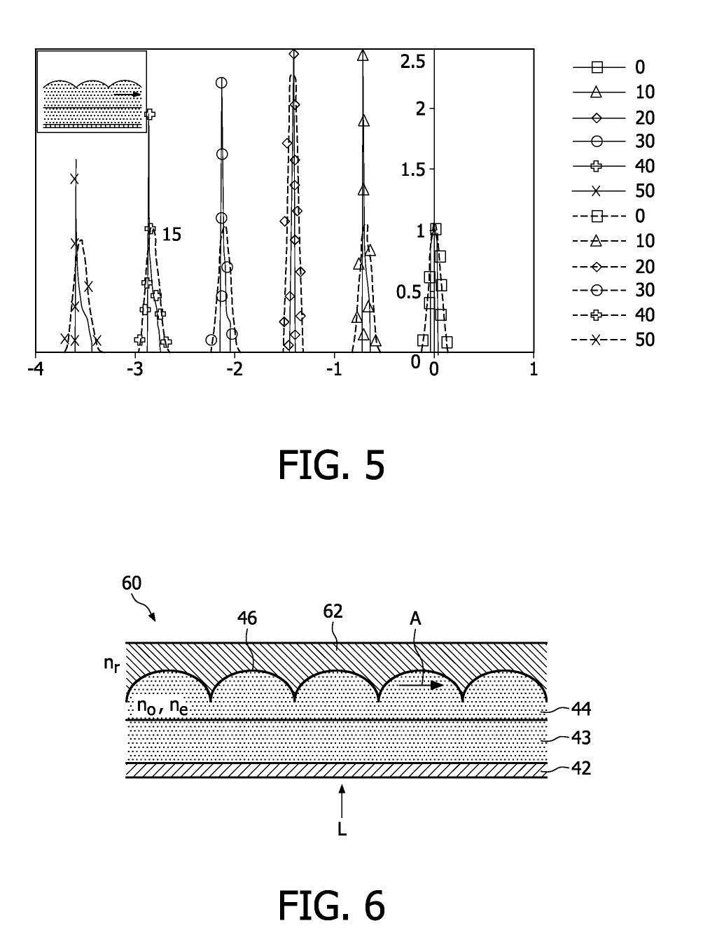

FIG. 5 is a graph illustrating a resultant relationship between intensity and position at the pixel plane contributing to an image produced by the device of FIG. 4 for viewing angles between 0° and 50°, wherein nₒ=1.0 and nₑ=1.5.

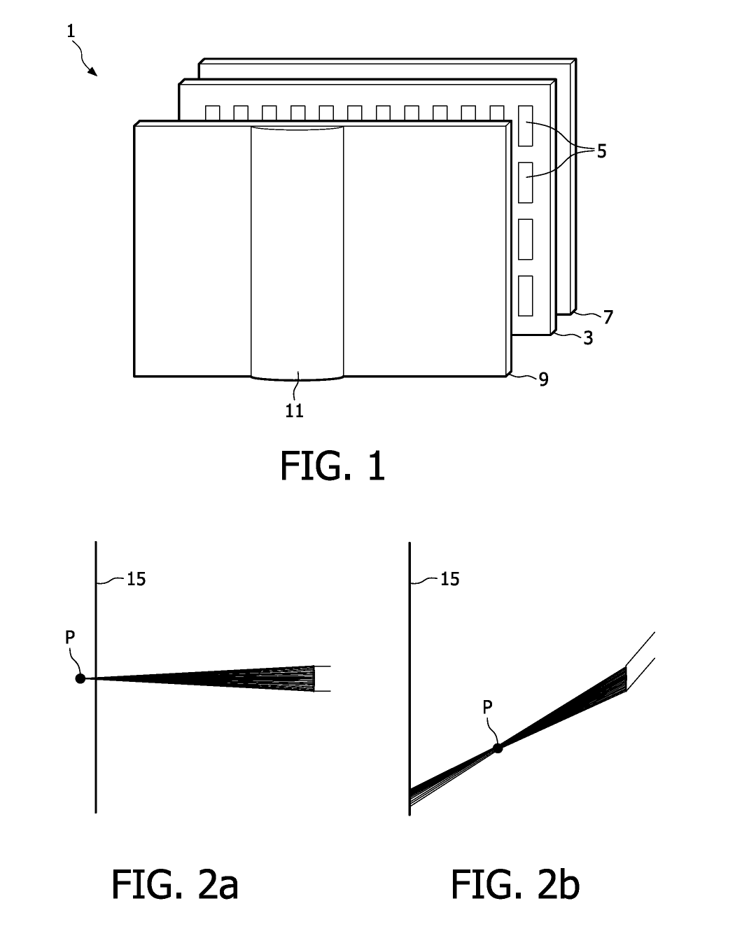

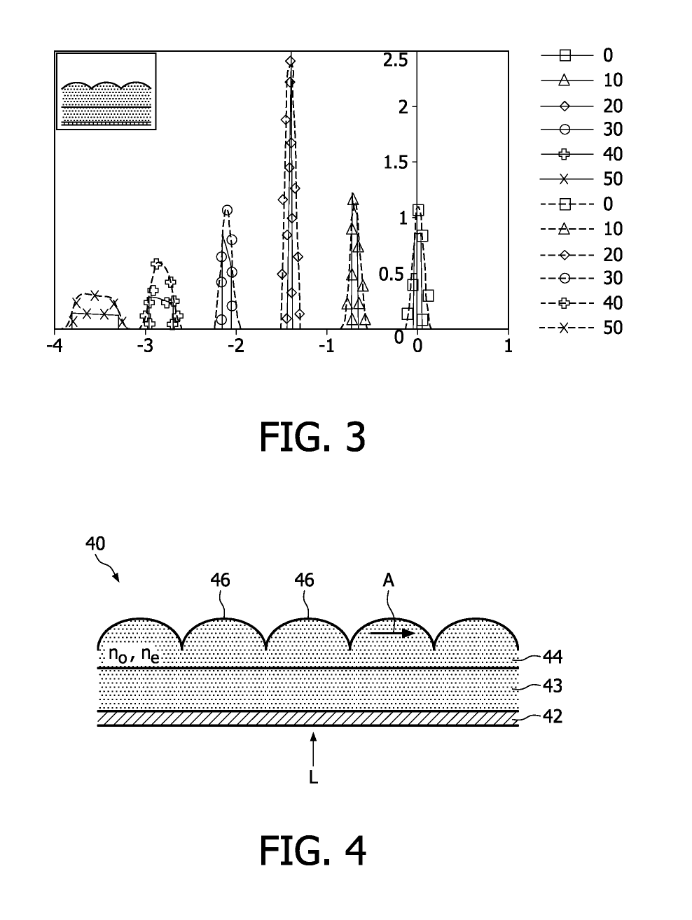

From the graph of FIG. 5, it can be seen that the focus size for viewing angles greater than 30° is improved (i.e. smaller) when compared to that of the device in FIG. 1 (as shown in FIG. 3). The reduced focus size, and increased intensity, for viewing angles greater than 30° means that there is less overlap between views and that the 3D impression is greater.

In reality, requiring a display device to comprise a birefringent material with these refractive indices is not practical. For example, typical refractive indices for known birefringent organic materials are nₒ=1.5, nₑ=1.8. Thus, although improved when compared to a known autostereoscopic device such as that of FIG. 1, a device according to the embodiment of FIG. 4 may in practice not quite achieve the reductions in blurring which are shown in FIG. 5.

Referring now to FIG. 6, an autostereoscopic display device 60 according to another embodiment of the invention is shown. The autostereoscopic display device 60 has a similar structure to the display device 40 of FIG. 4, but differs from this in that it further comprises a lenticular structure 62 of another material, hereinafter referred to as a replica, that fits accurately over the lenticular elements 46. This replica 62 is an isotropic material which has a refractive index nᵣ. Its provision has been found to cater for the non-ideal reductions in blurring that can be resultant from using known birefringent organic materials (for example, those with nₒ=1.5 and nₑ=1.8).

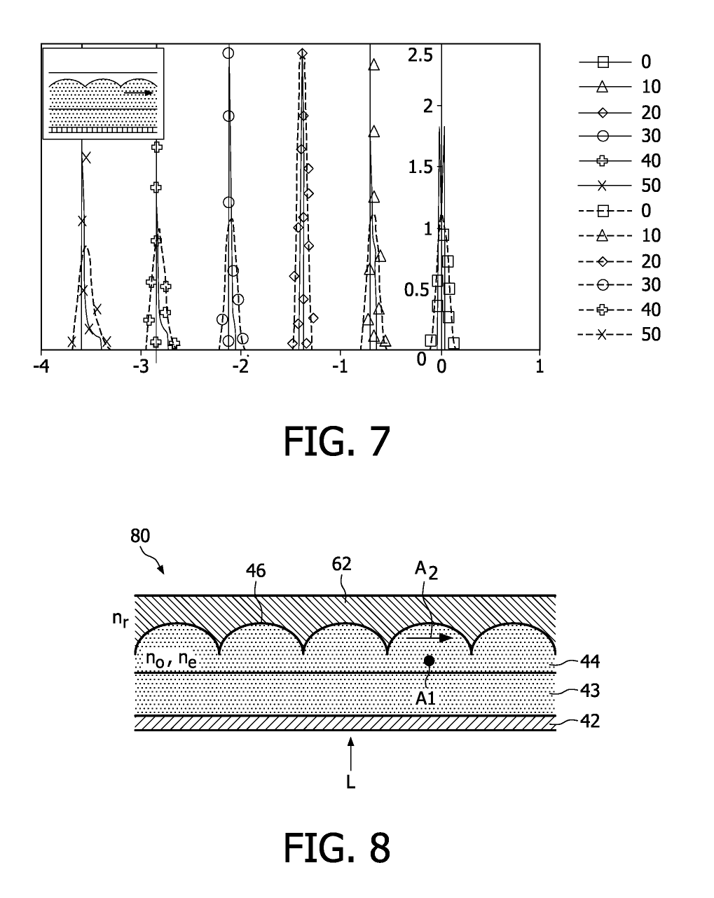

FIG. 7 is a graph illustrating a resultant relationship between intensity and position at the pixel plane contributing to an image produced by the device of FIG. 6 for viewing angles between 0° and 50°, wherein nₒ=1.5, nₑ=1.8 and nᵣ=1.5.

From the graph of FIG. 7, it can be seen that the focal size and intensity for viewing angles greater than 30° is similar to that of the device in FIG. 4 using ideal birefringent lenticular means (its relationship being shown in FIG. 5). Thus, a preferred reduction in focus size and blurring may be achieved from a device using known birefringent organic materials (i.e. those with nₒ=1.5 and nₑ=1.8), through the provision of an isotropic replica 62 layer covering the lenticular elements 46.

In the above-mentioned embodiments, the polarisation of the light L is assumed to be perpendicular to the cylinder axis of the lenticular elements 46. In practice, however, the polarisation direction is generally in another direction (typically parallel to the cylinder axis of the lenticular elements 46).

A first approach to cater for this difference in polarisation is to employ a half-lambda retarder to rotate the polarisation of the light into the desired direction.

A second approach is to use lenticular elements 46 with a twisted configuration of the extraordinary axis (similar to a concept of a twisted-nematic LCD). When the lenticular element is thick enough (for example, several tens of microns) the polarisation direction of the light will adiabatically follow that of the extraordinary axis.

Referring now to FIG. 8, an autostereoscopic display device 80 according to an alternative embodiment of the invention is shown. The autostereoscopic display device 80 has a similar structure to the display device 60 of FIG. 6, but differs from this in that the lenticular elements 46 are arranged to have a twisted configuration of the extraordinary axis. More specifically, the extraordinary axis at a first interface of the lenticular elements (as indicated generally by the arrow labelled “A1”) is substantially parallel to both the parallel axis of the lenticular elements 46 and the display panel 42. Further, the extraordinary axis at a second interface of the lenticular elements (as indicated generally by the arrow labelled “A2”) is substantially perpendicular to the parallel axis of the lenticular elements 46 and substantially parallel to the display panel 42. Thus, the lenticular elements 46 are provided with a twisted configuration of the extraordinary axis.

As mentioned above, by making the lenticular elements 46 to be of suitable thickness, the polarisation direction of light through the lenticular elements 46 will adiabatically follow that of the extraordinary axis (from A1 to A2).

Simulations have shown that, since the skew light rays will encounter a different effective index at the first lenticular interface, an optimal or preferred value for the refractive index nᵣ of the replica 62 will be different to that of a display device according to the invention which does not have a twisted extraordinary axis configuration (such as the device of FIG. 6).

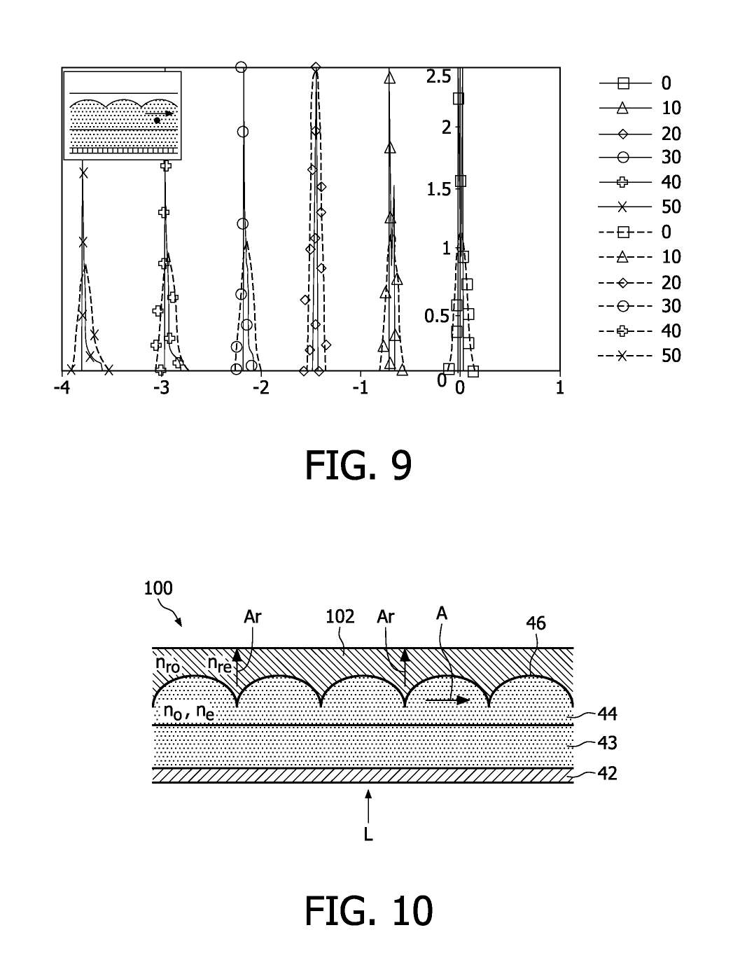

FIG. 9 is a graph illustrating a resultant relationship between intensity and position at the pixel plane contributing to an image produced by the device of FIG. 8 for viewing angles between 0° and 50°, wherein nₒ=1.5, nₑ=1.8 and nᵣ=1.6.

From the graph of FIG. 9, it can be seen that the focal size and intensity for viewing angles greater than 30° is similar to that of the device in FIG. 6 (as shown in FIG. 7). However, these results are for nᵣ=1.6 and provide preferable reductions in blurring when compared to the results for the same device having a replica with a refractive index nᵣ=1.5.

It will therefore be appreciated that although an autostereoscopic display device according to an embodiment of the invention can provide a reduction in blurring at large viewing angles, the amount of reduction may be dependent upon the actual refractive index values. Thus, the skilled reader will understand that particular refractive index values may be more preferable than others, and that such preferable values will depend upon the structure of the display device.

More generally, it has been demonstrated that it may be preferable to provide a display device according to the invention with birefringent lens material having an ordinary refractive index of 1.4-1.6, and an extraordinary refractive index of 1.6-1.8. It may also be further preferable to provide a replica arranged over the birefringent lens material, and to chose the replica material so that it has a refractive index of 1.4-1.7.

FIG. 10 shows an autostereoscopic display device 100 according to yet another embodiment of the invention. Again, the autostereoscopic display device 100 has a similar structure to the display device 60 of FIG. 6, but differs from this in that the replica 102 is formed from birefringent material having an ordinary refractive index denoted nᵣₒ and an extraordinary refractive index denoted nᵣₑ. The replica 102 is arranged such that its extraordinary axis (as indicated generally by the arrow labelled “Ar”) is perpendicular the display screen 42. In this case it is not necessary that the lenticular sheet is birefringent.

However, it is envisaged that it will be preferable to choose the birefringent replica 102 such that it has high refractive index (i.e. above 1.5 for example).

It will also be preferable to form the lenticular elements 46 such that they have a small radius of curvature if the refractive index difference between the replica 102 and the lenticular elements 46 is small. In other words, it is preferable in a device such as that shown in FIG. 10 to arrange the radius of curvature of the lenticular elements 46 to be directly proportional to the refractive index difference between the replica 102 and the lenticular elements 46.

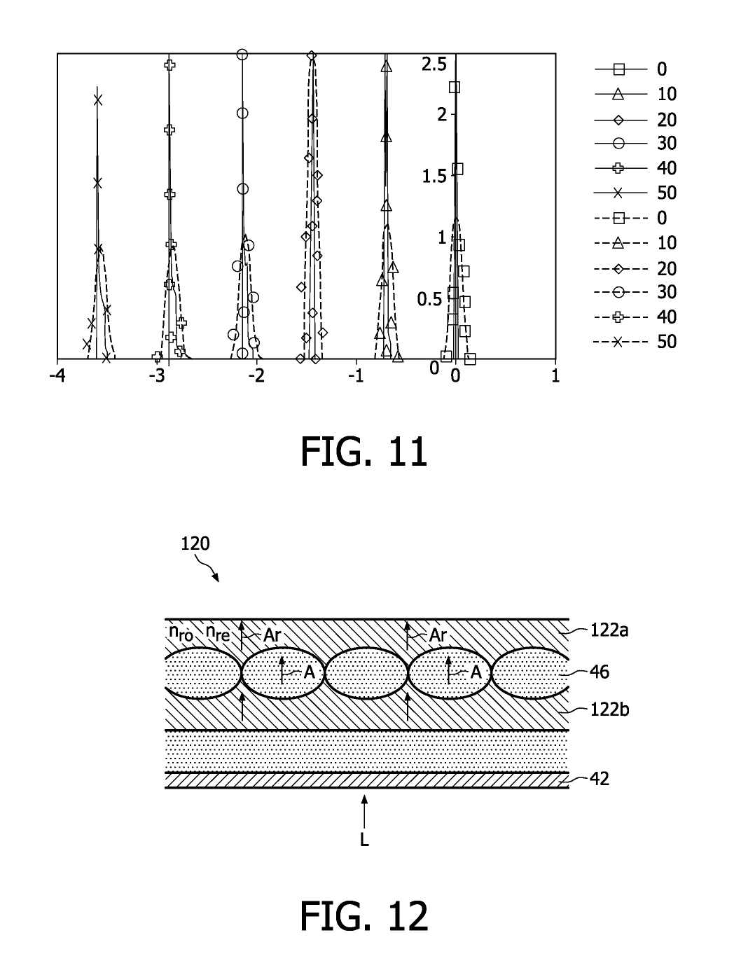

FIG. 11 is a graph illustrating a resultant relationship between intensity and position at the pixel plane contributing to an image produced by the device of FIG. 10 for viewing angles between 0° and 50°, wherein nₒ=nₑ=1.65, nᵣₑ=1.8 and nᵣₒ=1.5.

FIG. 12 shows an autostereoscopic display device 1020 according to another embodiment of the invention. The autostereoscopic display device 100 has a similar structure to the display device 100 of FIG. 10, but differs from this in that the lenticular elements 46 are bi-convex (rather than semi-cylindrical or planar convex) and that the replica 122 is formed above and below the array of lenticular elements 46. In this way, the array of cylindrical lenticular elements 46 is sandwiched between an upper replica layer 122a and a lower replica layer 122b, the replica being provided adjacent to the curved surfaces of the lenticular elements 46. Further, the extraordinary axis of the bi-convex lenticular elements 46 is arranged to be perpendicular to the parallel axis of the lenticular elements.

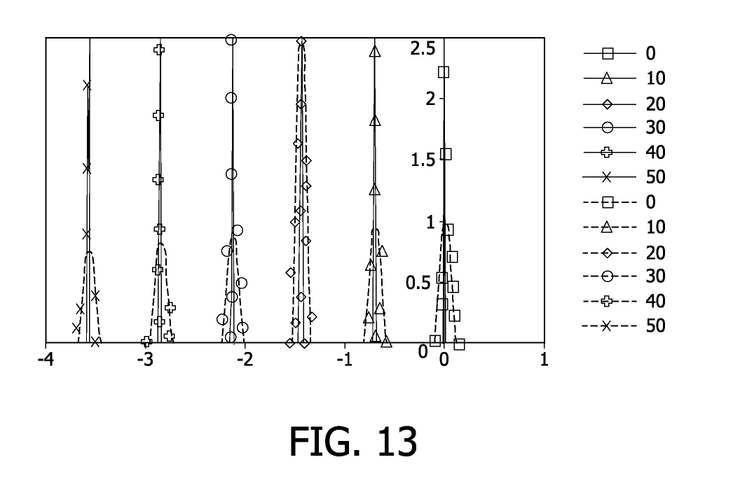

FIG. 13 is a graph illustrating a resultant relationship between intensity and position at the pixel plane contributing to an image produced by the device of FIG. 12 for viewing angles between 0° and 50°, wherein nₒ=nₑ=1.65, nᵣₑ=1.77 and nᵣₒ=1.55. It is noted that the extraordinary axis of the bi-convex lenticular elements 46 in FIG. 12 is perpendicular to the display panel 42. From this, it can be seen that blurring may be further diminished by using bi-convex lenticular elements within the birefringent lenticular sheet of an autostereoscopic display device according to the invention.

A number of possible configurations is set out above. More generally, the invention provides a design in which the different layers of the lenticular arrangement are designed (in terms of their refractive index values for isotropic layers, and their ordinary and extraordinary refractive indices as well as the axis of anisotropy for anisotropic layers) in such a way that light passing laterally through the lenticular arrangement passes through different refractive index boundaries than light passing normally through the lenticular arrangement. These different refractive index boundaries are designed so that the lensing performance results in a reduced lateral area of the display panel being focussed to a lateral view position. Preferably, the effective lens power is reduced for lateral light paths.

There are many ways in which this difference in lens function can be implemented. For example when there is a replica and a lens body, it is possible to choose which has the larger refractive index, to choose the orientation of the axis of anisotropy of the, or each, anisotropic layer, and to choose whether birefringence Δn is positive or negative.

For example, when employing an isotropic layer (either the lens layer or the replica layer), the following configurations are possible:

1) An isotropic replica (low refractive index n), birefringent lenticular elements with positive Δn and the extraordinary axis perpendicular to the elongate axis of the lenticular elements and parallel to the display panel;
2) An isotropic replica (low refractive index n), birefringent lenticular elements with negative Δn and the extraordinary axis perpendicular to the display panel and the elongate axis of the lenticular elements;
3) An isotropic lenticular elements (high refractive index n), birefringent replica with positive Δn and the extraordinary axis perpendicular to the display panel and the elongate axis of the lenticular elements; and
4) An isotropic lenticular elements (high refractive index n), birefringent replica with negative Δn and the extraordinary axis perpendicular to the elongate axis and parallel to the display.

One may even employ two birefringent materials, for example:

5) Birefringent lenticular elements with negative Δn with the extraordinary axis perpendicular to the display panel and the elongate axis of the lenticular elements, and a birefringent replica with positive Δn and its extraordinary axis perpendicular to the display and the elongate axis of the lenticular elements;
6) Birefringent lenticular elements with negative Δn and the extraordinary axis perpendicular to the display panel and the elongate axis of the lenticular elements, and a birefringent replica with negative Δn and the extraordinary axis perpendicular to the elongate axis of the lenticular elements and parallel to the display panel;
7) Birefringent lenticular elements with positive Δn and the extraordinary axis perpendicular to the elongate axis of the lenticular elements and parallel to the display, and a birefringent replica with positive Δn and its extraordinary axis perpendicular to the display panel and the elongate axis of the lenticular elements;
8) Birefringent lenticular elements with positive Δn and the extraordinary axis perpendicular to the elongate axis of the lenticular elements and parallel to the display panel, and a birefringent replica with negative Δn and its extraordinary axis perpendicular to the elongate axis of the lenticular elements and parallel to the display panel.

Thus, it will be understood that either the lenticular elements or the replica may be birefringent. In the eight configurations listed above, the polarisation of the light should preferably be in the plane perpendicular to the elongate axis of the lenticular elements.

It should be noted that the above-mentioned embodiments illustrate rather than limit the invention, and at that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that the combination of these measures cannot be used to advantage.

Summarizing a lens structure for a display device comprises a lenticular arrangement, the lenticular arrangement comprising an array of parallel lenticular elements and comprising a birefringent layer. The extraordinary axis of the birefringent layer is arranged to be substantially at an angle between 30° and 90° with the elongate axis of the lenticular elements.

1. A lens structure for an autostereoscopic display device comprising
a lenticular arrangement, the lenticular arrangement comprising an array of parallel lenticular elements and comprising a birefringent layer,
wherein the extraordinary axis of the birefringent layer is arranged to be at an angle between 30° and 90° with the elongate axis of the lenticular elements.

2. A lens structure as claimed in claim 1, wherein the extraordinary axis of the birefringent layer is perpendicular to the elongate axis of the lenticular elements.

3. A lens structure as claimed in claim 1, wherein the extraordinary axis of the birefringent layer is parallel to a plane of the lenticular arrangement.

4. A lens structure according to claim 1, wherein the extraordinary axis at a first interface of the birefringent layer is twisted from that at a second interface of the birefringent layer.

5. A lens structure according to claim 1, further comprising a half-lambda wave plate for rotating the polarisation direction between the interfaces of the birefringent layer.

6. A lens structure according to claim 1, wherein the array of lenticular elements comprises bi-convex lenses.

7. A lens structure according to claim 1, wherein the lenticular arrangement comprises a lens layer and a replica layer arranged over the lens layer.

8. A lens structure according to claim 7, wherein the replica layer has a different refractive index to the lens layer.

9. A lens structure according to claim 7, wherein the replica layer is isotropic.

10. A lens structure according to claim 7, wherein the replica layer is birefringent.

11. A lens structure according to claim 1, wherein the lens layer is birefringent and comprises the birefringent layer.

12. A lens structure according to claim 1, further comprising polarisation means arranged over at least a portion of the lenticular arrangement.

13. An autostereoscopic display device comprising:
a display panel for producing a display; and
a lens structure according to claim 1.

14. A display device as claimed in claim 13, wherein the display panel output is polarized in a plane perpendicular to the axis of the lenticular elements of the lens structure.

15. A display device according to claim 13, wherein the orientation of the extraordinary axis of the birefringent layer is switchable by selective application of an electric field so as switch the display between 2D and 3D modes of operation.

16. A display device according to claim 13, wherein the display panel is a liquid crystal display panel.

17. A method of displaying an autostereoscopic image, comprising:
generating an image comprising multiple views;
projecting the image through a lens structure comprising an array of parallel lenticular elements and comprising a birefringent layer,
wherein the extraordinary axis of the birefringent layer is arranged to be perpendicular to the elongate axis of the lenticular elements, and wherein the generated image is arranged to be polarized in a plane perpendicular to the axis of the lenticular elements of the lens structure.
